(19) United States
(12) Patent Application Publication
(10) Pub. No.: US 2012/0212578 A1
(43) Pub. Date: Aug. 23, 2012

(54) METHOD AND APPARATUS OF CODING STEREOSCOPIC VIDEO

(75) Inventors: Bong Ho LEE, Daejeon (KR); Won Sik CHEONG, Daejeon (KR); Nam Ho HUR, Daejeon (KR); Byung Tak LEE, Goyang-si Gyeonggi-do (KR); Jae Gon KIM, Goyang-si Gyeonggi-do (KR)

(73) Assignees: Industry-University Cooperation Foundation Korea Aerospace University, Goyang-si Gyeonggi-do (KR); Electronics and Telecommunications Research Institute, Daejeon (KR)

(21) Appl. No.: 13/341,757

(22) Filed: Dec. 30, 2011

(30) Foreign Application Priority Data
Feb. 22, 2011 (KR) 10-2011-0015659

(51) Int. Cl. H04N 13/00

(52) U.S. Cl. 348/43; 348/E13.062

(57) ABSTRACT

Disclosed are a method and an apparatus for coding a stereoscopic video. The method of coding a stereoscopic video includes coding an original reference image; performing preprocessing based on the original reference image, a decoded reference image, and an original additional image; coding the original addition image based on the original additional image and an improved decoding image obtained by performing the preprocessing; and performing postprocessing based on the original additional image and a decoded additional image.

### CROSS-REFERENCE TO RELATED APPLICATIONS

This application claims the benefit of priority of Korean Patent application No. 10-2011-0015659 filed on Feb. 22, 2011, which is incorporated by reference in its entirety herein.

### BACKGROUND OF THE INVENTION

1. Field of the Invention

The present invention relates to digital broadcasting, and more particularly, to a method and an apparatus of coding a stereoscopic video.

2. Related Art

Stereoscopy means a technology that individually provides two offset images to a left eye and a right eye of a viewer, respectively, to create or improve illusion of depth. A 3D image may be provided by the stereoscopy. A stereoscopic video means an image created by the stereoscopy.

It is important to maintain backward compatibility with the existing 2D image user while providing the 3D image, by using the stereoscopic video. That is, there is a need to provide a new 3D image while maintaining service quality of the 2D image. As a result, a need exists for a technology for effectively coding the stereoscopic video for 3D broadcasting in digital broadcasting, in particular, terrestrial broadcasting having a limited bandwidth.

The stereoscopic video has data amount two times larger than the existing mono video and therefore, requires a double bandwidth. In addition, the stereoscopic video is an image captured by two adjacent cameras, such that spatial redundancy between left and right images is increased. Therefore, various technologies of coding a stereoscopic video using a method of removing and compressing redundant information have been researched and standardization of multi-view video coding (MVC) codec was completed in 2008 under the leadership of Joint Video coding Team (JVT). The MVC codec uses disparity estimation based on an inter-pixel brightness difference between left and right images when compressing the stereoscopic video. However, the inter-pixel brightness difference of the left and right images may frequently occur due to a minute difference in a focal distance, a distance, a relative position, an amount of light incident on an iris, or the like, when performing the disparity estimation. Therefore, it may be difficult to efficiently remove spatial redundancy between the left and right images.

Therefore, a need exists for a method and an apparatus of coding a stereoscopic video for effectively removing coding loss occurring during a coding process while effectively removing the spatial redundancy between the left and right images.

### SUMMARY OF THE INVENTION

The present invention provides a method and an apparatus of coding a stereoscopic video.

In an aspect, a method of coding a stereoscopic video is provided. The method includes coding an original reference image, performing preprocessing based on the original reference image, a decoded reference image, and an original additional image, coding the original addition image based on the original additional image and an improved decoding image obtained by performing the preprocessing, and performing postprocessing based on the original additional image and a decoded additional image.

The performing preprocessing may comprise performing pre-image filtering on the decoded reference image.

The pre-image filtering may be performed based on at least one of adaptive loop filters (ALF) based on a deblocking filter or a Wiener filter.

The performing preprocessing may comprise performing global motion transform using the decoded reference image and the original additional image as an input.

The global motion transform may be applied with one of global motion transform models of Affine, Perspective, and Polynomial.

The performing preprocessing may further comprise performing post-image filtering on a global motion transform image output by the global motion transform.

The post-image filtering may be performed based on at least one of adaptive loop filters based on a deblocking filter or a Wiener filter.

The performing of the postprocessing may comprise performing image filtering on the decoded additional image.

The image filtering may be performed based on at least one of adaptive loop filters based on a deblocking filter or a Wiener filter

The original reference image may be coded with a motion picture experts group (MPEG)-2 video.

The method may further comprise performing entropy decoding on additional data generated by the performing preprocessing or the performing postprocessing.

In another aspect, a method of decoding stereoscopic video is provided. The method includes decoding a received reference image bit stream, performing preprocessing on a received additional data bit stream based on the decoded reference image, decoding an additional image based on a received additional image bit stream and an improved decoding image obtained by the preprocessing performance, and performing postprocessing on the received additional data bit stream.

The performing preprocessing may comprise performing pre-image filtering on the decoded reference image.

The performing preprocessing may comprise performing global motion transform using the decoded reference image as an input.

The performing preprocessing may further comprise performing post-image filtering on a global motion transform image output by the global motion transform.

The performing postprocessing may comprise performing image filtering on the decoded additional image.

The received reference image bit stream may be decoded with a motion picture experts group (MPEG)-2 video.

The method may further comprise performing entropy decoding on the received additional data bit stream.

### BRIEF DESCRIPTION OF THE DRAWINGS

FIG. 1 is an exemplary embodiment of a method of coding a stereoscopic video.

FIG. 2 is an exemplary embodiment of a preprocessing process.

FIG. 3 is another exemplary embodiment of the preprocessing process.

FIG. 4 is another exemplary embodiment of the preprocessing process.

FIG. 5 is another exemplary embodiment of the preprocessing process.

FIG. 6 is another exemplary embodiment of the preprocessing process.

FIG. 7 is an exemplary embodiment of a postprocessing process.

FIG. 8 is an exemplary embodiment of a method of decoding a stereoscopic video.

FIG. 9 is an example of a block diagram of a stereoscopic video codec apparatus.

### DESCRIPTION OF EXEMPLARY EMBODIMENTS

Hereinafter, embodiments of the present invention will be described in detail with reference to the accompanying drawings so that those skilled in the art may easily practice the present invention. However, the present invention may be modified in various different ways and is not limited to the embodiments provided in the present description. In the accompanying drawings, portions unrelated to the description will be omitted in order to obviously describe the present invention, and similar reference numerals will be used to describe similar portions throughout the present specification.

Throughout the present specification, unless explicitly described to the contrary, “comprising” any components will be understood to imply the inclusion of other elements rather than the exclusion of any other elements

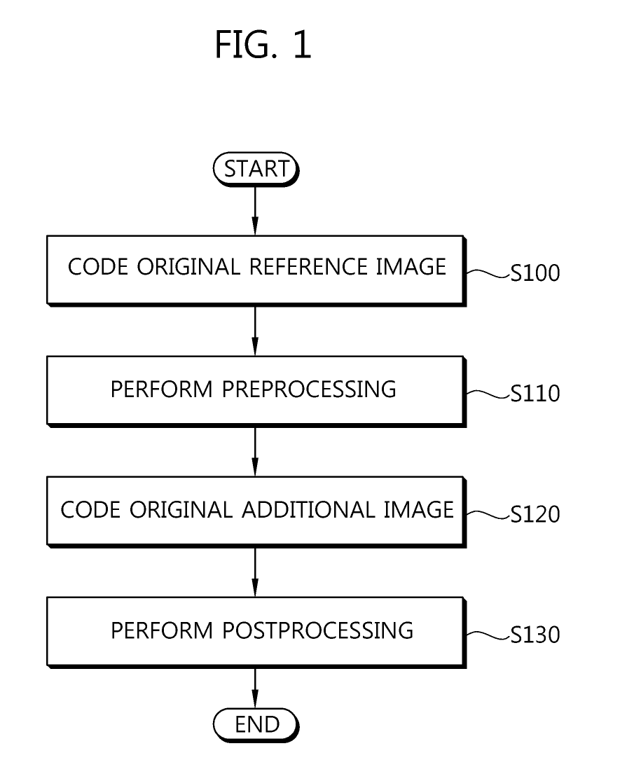

FIG. 1 is an exemplary embodiment of a method of coding a stereoscopic video.

Referring to FIG. 1, at step S100, a coder codes an original reference image. In this case, a reference image bit stream may be generated. The original reference image may be coded with a motion picture experts group (MPEG)-2 video. The MPEG-2 video means ISO/IEC 13818-2 Information technology—Generic coding of moving pictures and associated audio information: video standard. Alternatively, the original reference image may also be coded with other formats of videos, in addition to the MPEG-2 video, the exemplary embodiments of the present invention is not limited thereto.

At step S110, a coder performs preprocessing based on the original reference image, a decoded reference image, and an original additional image. Therefore, an improved decoding image may be obtained. Further, an additional data bit stream may be generated during the preprocessing process.

At step S120, the coder codes the original additional image. In this case, this may be based on the improved decoding image. As the coding method, any method of referring to a reference image such as MPEG-2 Multi-view Profile, H.264/MVC (Multi-view Video Coding) Stereo High Profile may be used. Alternatively, a new coding method may also be used. Further, an additional image bit stream may be generated.

At step S130, the coder performs postprocessing based on the original additional image and the decoded additional image. Therefore, the decoding image with the improved quality of image may be obtained. Further, the additional data bit stream may also be generated during the postprocessing process.

The preprocessing process at step S110 of FIG. 1 may be performed by various methods. Hereinafter, the preprocessing process at step S110 of FIG. 1 will be described in detail.

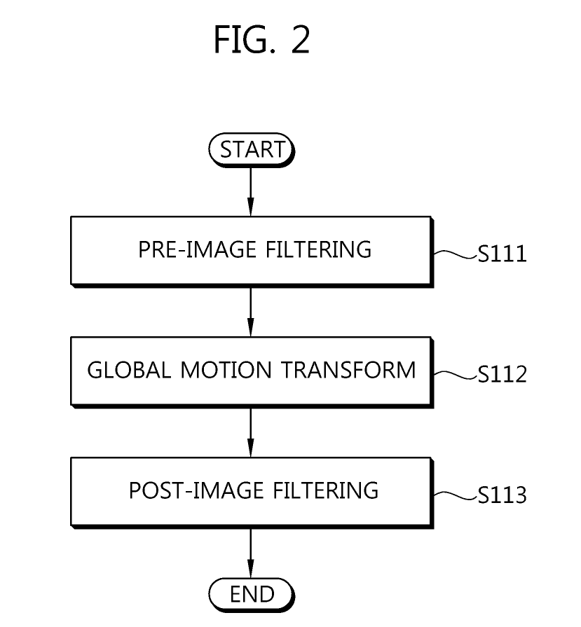

FIG. 2 is an exemplary embodiment of a preprocessing process.

Referring to FIG. 2, at step S111, the coder performs pre-image filtering on the decoded reference image. In performing the pre-image filtering, at least one of adaptive loop filters (ALFs) based on a deblocking filter or a Wiener filter may be used.

At step S112, the coder performs global motion transform using as an input the decoded reference image and the original additional image which are subjected to the pre-image filtering. A global motion transform image is output by performing the global motion transform. In performing the global motion transform, various global motion transform model, such as, Affine, Perspective, Polynomial, or the like, may be used.

At step S113, the coder performs post-image filtering using the global motion transform image and the original additional image as the input. The improved decoding image may be obtained by the post-image filtering. When performing the post-image filtering, at least one of the adaptive loop filters based on the deblocking filter or the Wiener filter may be used, similar to the image filtering process at step S111.

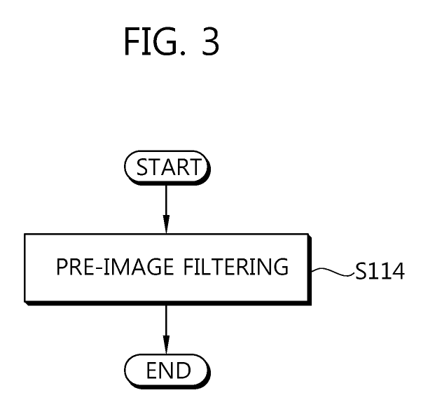

FIG. 3 is another exemplary embodiment of the preprocessing process.

The preprocessing process of FIG. 3 includes only the pre-image filtering process during the preprocessing process of FIG. 2. At step S114, the coder performs the pre-image filtering on the decoded reference image. The pre-image filtering process at step S114 may perform the same function as the pre-image filtering process at step S111 of FIG. 2.

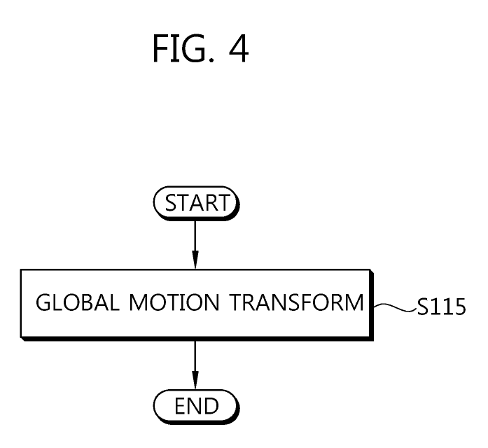

FIG. 4 is another exemplary embodiment of the preprocessing process.

The preprocessing process of FIG. 4 includes only the global motion transform process during the preprocessing process of FIG. 2. At step S115, the coder performs the global motion transform by using the decoded reference image and the original additional image as the input. The global motion transform process at step S115 may perform the same function as the global motion transform process at step S111 of FIG. 2.

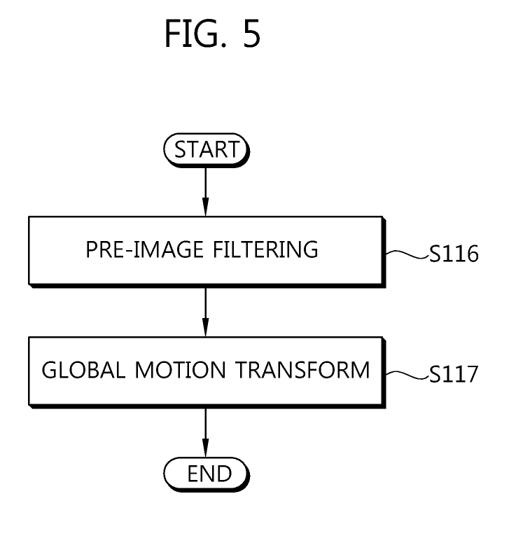

FIG. 5 is another exemplary embodiment of the preprocessing process.

The preprocessing process of FIG. 5 includes only the pre-image filtering process and the global motion transform process during the preprocessing process of FIG. 2. At step S116, the coder performs the pre-image filtering on the decoded reference image. The pre-image filtering process at step S116 may perform the same function as the pre-image filtering process at step S111 of FIG. 2. At step S117, the coder performs the global motion transform using as the input the decoded reference image and the original additional image which are subjected to the pre-image filtering. The global motion transform process at step S117 may perform the same function as the global motion transform process at step S112 of FIG. 2.

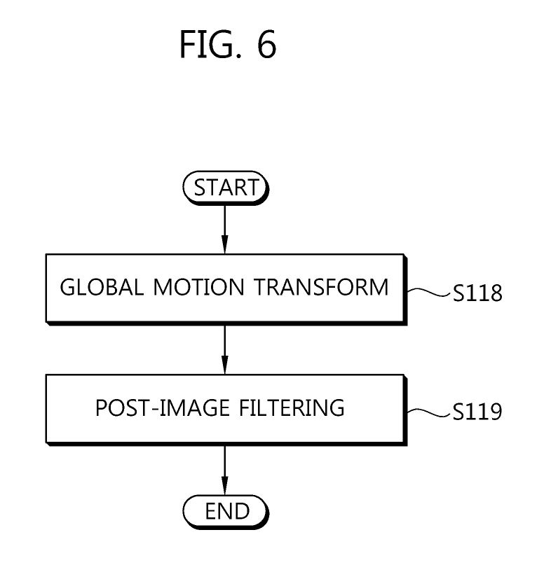

FIG. 6 is another exemplary embodiment of the preprocessing process.

The preprocessing process of FIG. 6 includes the global motion transform process and the post-image filtering process during the preprocessing process of FIG. 2. At step S118, the coder performs the global motion transform by using the decoded reference image and the original additional image as the input. The global motion transform process at step S118 may perform the same function as the global motion transform process at step S112 of FIG. 2. At step S119, the coder performs the post-image filtering using the global motion transform image output during the global motion transform process and the original additional image as the input. The post-image filtering process at step S119 may perform the same function as the post-image filtering process at step S113 of FIG. 2.

The example of the preprocessing process of various methods of combining the pre-image filtering, the global motion transform, and the post-image filtering were described with reference to FIGS. 2 to 6, but the exemplary embodiment of the present invention is not limited thereto. Therefore, the preprocessing process of a new combination may also be applied to the exemplary embodiment of the present invention. In addition, the preprocessing process may be performed by non-explained methods, in addition to the pre-image filtering, the global motion transform, and the post-image filtering.

As the preprocessing process may be performed by various methods, so the postprocessing process at step S130 of FIG. 1 may also be performed by various methods.

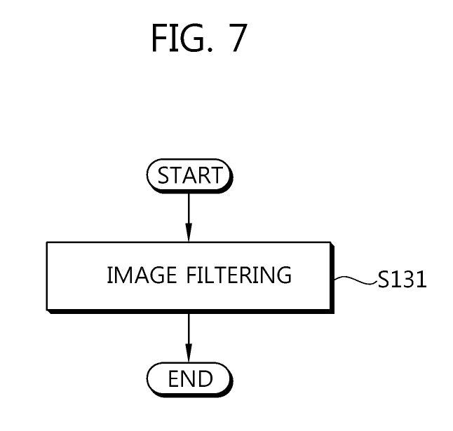

FIG. 7 is an exemplary embodiment of a postprocessing process.

Referring to FIG. 7, at step S131, the coder performs the image filtering on the decoded additional images. In performing the image filtering, at least one of the adaptive loop filters based on the deblocking filter or the Wiener filter may be used.

Meanwhile, entropy coding may be further performed on the additional data during the preprocessing process or the postprocessing process. The additional data may be filter coefficients or transform coefficients generated during the preprocessing process or the postprocessing process. The additional data bit stream may be generated by the entropy coding.

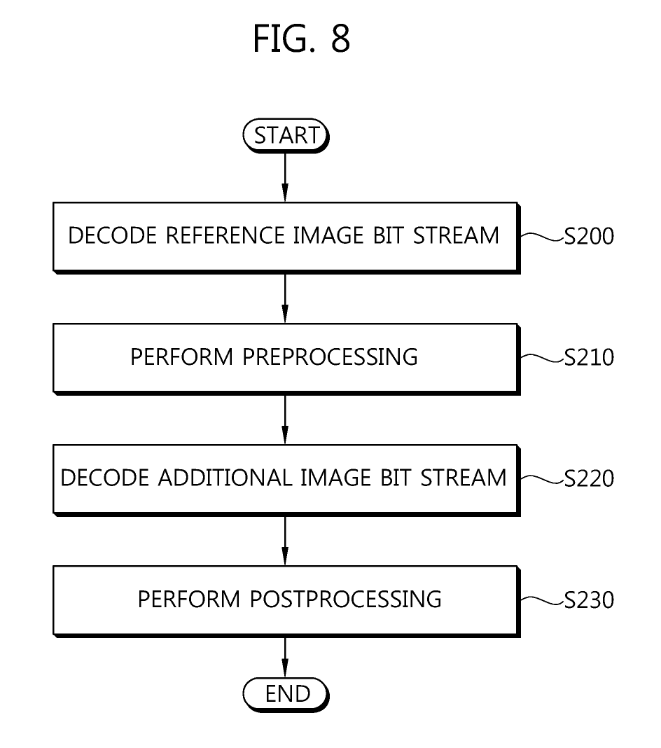

FIG. 8 is an exemplary embodiment of a method of decoding a stereoscopic video.

Referring to FIG. 8, at step S200, the decoder decodes the reference image bit stream received from the coder. The received reference image bit stream maybe decoded with the MPEG-2 video. However, the exemplary embodiment of the present invention is not limited thereto and therefore, the received reference image bit stream may be decoded with various formats of video.

At step S210, the decoder performs the preprocessing on the additional data bit stream received from the coder. The decoder may decode the received additional data bit stream based on the decoded reference image. Therefore, the improved decoding image may be obtained, like one generated in the decoder.

At step S220, the decoder decodes the additional image based on the improved decoding image and the additional image bit stream received from the coder.

At step S230, the decoder performs the postprocessing on the additional data bit stream received from the coder. The decoder may decode the received additional data bit stream. Therefore, the improved decoding image may be obtained, like one generated in the decoder.

Similarly to the preprocessing process at step S110 of FIG. 1, the preprocessing process at step S210 of FIG. 8 may also be performed by various methods. The preprocessing process at step S210 may be performed by the exemplary embodiment of FIGS. 2 to 6.

In addition, similarly to the postprocessing process at step S130 of FIG. 8, the postprocessing process at step S230 of FIG. 8 may also be by various methods. The postprocessing process at step S230 may be performed by the exemplary embodiment of FIG. 7.

Meanwhile, the entropy decoding may be further performed on the additional data bit stream during the preprocessing process or the postprocessing process. Therefore, the additional data, such as the filter coefficient or the transform coefficient, or the like, may be output.

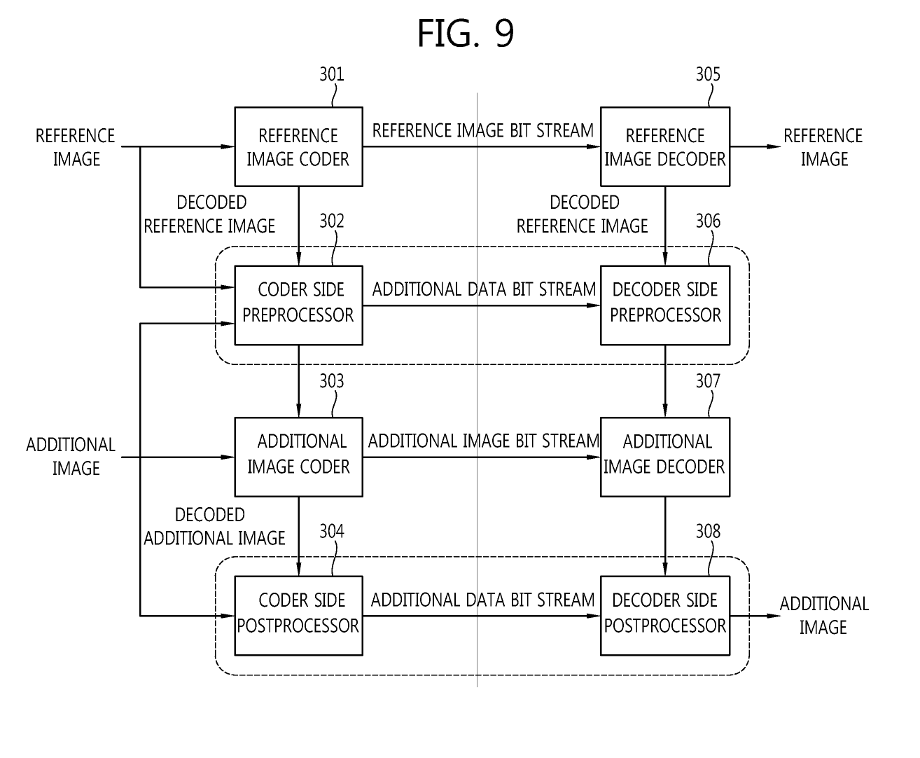

FIG. 9 is an example of a block diagram of a stereoscopic video codec apparatus. The stereoscopic video codec apparatus largely includes the stereoscopic video decoder and the stereoscopic decoder.

Referring to FIG. 9, the stereoscopic video coder of the stereo video codec apparatus includes a reference image coder 310, a coder side preprocessor 302, an additional image coder 303, and a coder side postprocessor 304. The stereoscopic video decoder of the stereo video codec apparatus includes a reference image decoder 305, a decoder side preprocessor 306, an additional image decoder 307, and a decoder side postprocessor (308).

The reference image coder 301 codes the original reference image and transmits the reference image bit stream to the decoder 305. The original reference image may be coded with the MPEG-2 video or other formats of videos.

The coder side preprocessor 302 is connected to the reference image coder 301. The decoder side preprocessor 302 performs the preprocessing based on the original reference image, the decoded reference image, and the original additional image. Therefore, the improved decoding image may be obtained. In addition, the coder side preprocessor 302 may create the additional information generated during the preprocessing process into the additional information bit stream and transmit the created additional information bit stream to the decoder side preprocessor 306.

The additional image coder 303 is connected to the coder side preprocessor 302. The additional image coder 303 codes the original additional image based on the improved decoding image and the original additional image that are generated in the coder side preprocessor 302. As the coding method, any method of referring to a reference image such as MPEG-2 Multi-view Profile, H.264/MVC Stereo High Profile, or the like, may be used. Alternatively, a new coding method may also be used. In addition, the additional image coder 303 may transmit the generated additional image bit stream to the additional image decoder 307.

The coder side postprocessor 304 is connected to the additional image coder 303. The coder side postprocessor 304 performs the postprocessor based on the original additional image and the decoded additional image to obtain the decoding image with the improved image quality. In addition, the coder side postprocessor 304 may transmit the additional data stream obtained by making the additional data generated during the postprocessing process into a stream to the decoder side preprocessor 308.

The reference image decoder 305 decodes the reference image bit stream received from the reference image coder 301. The received reference image bit stream may be decoded with the MPEG-2 video or other formats of videos.

The decoder side preprocessor 306 is connected to the reference image decoder 305. The decoder side preprocessor 306 decodes the additional data bit stream received from the coder side preprocessor 302. Therefore, the improved decoding image may be obtained, like one generated in the coder side preprocessor 302.

The additional image decoder 307 is connected to the decoder side preprocessor 306. The additional image decoder 307 decodes the additional image based on the additional image bit stream and the improved decoding image that are received from the additional image coder 303.

The decoder side postprocessor 308 is connected to the additional image decoder 307. The decoder side postprocessor 308 decodes the additional data bit stream received from the decoder side postprocessor 304. Therefore, the improved decoding image may be obtained, like one generated in the coder side postprocessor 304.

Meanwhile, although the block diagram of FIG. 9 separately describes the coder and the decoder, but the exemplary embodiment of the present invention is not limited thereto. The coder side preprocessor 302 and the decoder side preprocessor 306 of FIG. 9 may be present in both of the stereoscopic coder and decoder. Similarly, the coder side postprocessor 304 and the decoder side postprocessor 308 of FIG. 9 may also be present in both of the stereoscopic coder and decoder. In addition, the preprocessor and the postprocessor may be applied in various combinations, considering the complexity and performance of the stereoscopic coder and decoder.

According to the exemplary embodiment of the present invention, the coding efficiency of the stereoscopic video may be improved. The exemplary embodiment of the exemplary embodiment of the present invention may be applied to non real-time 3DTV broadcasting services and may also be applied to the 3DTV broadcasting services having various networks, such as terrestrial wave, cable, satellite, Internet, or the like.

The exemplary embodiments of the present invention may be implemented by hardware, software, or a combination thereof. The hardware may be implemented by an application specific integrated circuit (ASIC), digital signal processing (DSP), a programmable logic device (PLD), a field programmable gate array (FPGA), a processor, a controller, a microprocessor, other electronic units, or a combination thereof, all of which are designed so as to perform the above-mentioned functions. The software may be implemented by a module performing the above-mentioned functions. The software may be stored in a memory unit and may be executed by a processor. The memory unit or a processor may adopt various units well-known to those skilled in the art.

As set forth above, the exemplary embodiments of the present invention can improve the coding efficiency of the stereoscopic video by improving the coding efficiency of the additional images.

In the above-mentioned exemplary embodiments, the methods are described based on the series of steps or the flow charts shown by a block, but the exemplary embodiments of the present invention are not limited to the order of the steps and any steps may be performed in order different from the above-mentioned steps or simultaneously. In addition, a person skilled in the art to which the present invention pertains may understand that steps shown in the flow chart are not exclusive and thus, may include other steps or one or more step of the flow chart may be deleted without affecting the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belonging to the following claims.

What is claimed is:

1. A method of coding a stereoscopic video, the method comprising:
coding an original reference image;
performing preprocessing based on the original reference image, a decoded reference image, and an original additional image;
coding the original addition image based on the original additional image and an improved decoding image obtained by performing the preprocessing; and
performing postprocessing based on the original additional image and a decoded additional image.

2. The method of claim 1, wherein the performing preprocessing comprises performing pre-image filtering on the decoded reference image.

3. The method of claim 2, wherein the pre-image filtering is performed based on at least one of adaptive loop filters (ALF) based on a deblocking filter or a Wiener filter.

4. The method of claim 1, wherein the performing preprocessing comprises performing global motion transform using the decoded reference image and the original additional image as an input.

5. The method of claim 4, wherein the global motion transform is applied with one of global motion transform models of Affine, Perspective, and Polynomial.

6. The method of claim 4, wherein the performing preprocessing further comprises performing post-image filtering on a global motion transform image output by the global motion transform.

7. The method of claim 6, wherein the post-image filtering is performed based on at least one of adaptive loop filters based on a deblocking filter or a Wiener filter.

8. The method of claim 1, wherein the performing postprocessing comprises performing image filtering on the decoded additional image.

9. The method of claim 8, wherein the image filtering is performed based on at least one of adaptive loop filters based on a deblocking filter or a Wiener filter

10. The method of claim 1, wherein the original reference image is coded with a motion picture experts group (MPEG)-2 video.

11. The method of claim 1, further comprising performing entropy decoding on additional data generated by the performing preprocessing or the performing postprocessing.

12. A method of decoding stereoscopic video, the method comprising:
decoding a received reference image bit stream;
performing preprocessing on a received additional data bit stream based on the decoded reference image;
decoding an additional image based on a received additional image bit stream and an improved decoding image obtained by the preprocessing performance; and
performing postprocessing on the received additional data bit stream.

13. The method of claim 12, wherein the performing preprocessing comprises performing pre-image filtering on the decoded reference image.

14. The method of claim 12, wherein the performing preprocessing comprises performing global motion transform using the decoded reference image as an input.

15. The method of claim 13, wherein the performing preprocessing further comprises performing post-image filtering on a global motion transform image output by the global motion transform.

16. The method of claim 12, wherein the performing postprocessing comprises performing image filtering on the decoded additional image.

17. The method of claim 12, wherein the received reference image bit stream is decoded with a motion picture experts group (MPEG)-2 video.

18. The method of claim 12, further comprising performing entropy decoding on the received additional data bit stream.
